(19) United States
(12) Patent Application Publication
(10) Pub. No.: US 2026/0329945 A1
(43) Pub. Date: Oct. 22, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventors: Akinori EBIHARA, Tokyo (JP); Taiki MIYAGAWA, Tokyo (JP)

(73) Assignee: NEC Corporation, Minato-ku, Tokyo (JP)

(21) Appl. No.: 19/112,411

(22) PCT Filed: Oct. 13, 2022
(86) PCT No.: PCT/JP2022/038258

§ 371 Date: Mar. 17, 2025

(51) Int. Cl. G06F 16/906; G06F 17/12

(52) U.S. Cl. CPC G06F 16/906; G06F 17/12

(57) ABSTRACT

An information processing apparatus includes: an acquisition unit that acquires a plurality of elements included in series data; a calculation unit that calculates a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and a classification unit that classifies the series data into at least one class of a plurality of classes serving as classification candidates, based on the likelihood ratio. According to such an information processing apparatus, it is possible to achieve both accurate likelihood ratio estimation and stability of learning.

### TECHNICAL FIELD

The present disclosure relates to technical fields of an information processing apparatus, an information processing method, and a recording medium.

### BACKGROUND ART

A known apparatus of this type performs class classification of series data by using a likelihood ratio. For example, Patent Literature 1 discloses that the series data are classified into any one of a plurality of predetermined classes by sequentially acquiring and analyzing a plurality of elements included in the series data.

As another related technique/technology, for example, Patent Literature 2 discloses that a log-sum-exp type loss function is used to perform learning about calculation of a likelihood ratio. Patent Literature 3 discloses that an estimation method that minimizes a KL length, i.e., KLIEP (Kullback Leibler Importance Estimation Procedure), is used to estimate a log-likelihood ratio.

### CITATION LIST

### Patent Literature

Patent Literature 1: International Publication No. WO 2020/194497

Patent Literature 2: International Publication No. WO 2022/157973

Patent Literature 3: International Publication No. WO 2021/229663

### SUMMARY

### Technical Problem

The present disclosure aims to improve the techniques/technologies disclosed in Citation List.

### Solution to Problem

An information processing apparatus according to an example aspect of the present disclosure includes: an acquisition unit that acquires a plurality of elements included in series data; a calculation unit that calculates a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and a classification unit that classifies the series data into at least one class of a plurality of classes serving as classification candidates, based on the likelihood ratio.

An information processing method according to an example aspect of the present disclosure includes: acquiring a plurality of elements included in series data; calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and classifying the series data into at least one class of a plurality of classes serving as classification candidates, based on the likelihood ratio.

A recording medium according to an example aspect of the present disclosure is a recording medium on which a computer program that allows at least one computer to execute an information processing method is recorded, the information processing method including: acquiring a plurality of elements included in series data; calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and classifying the series data into at least one class of a plurality of classes serving as classification candidates, based on the likelihood ratio.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a graph illustrating, with a comparative example, an example of a likelihood ratio calculated by the information processing apparatus according to the first example embodiment.

FIG. 5 is a graph illustrating an example of an activation function used in an information processing apparatus according to a second example embodiment.

FIG. 6 is a graph illustrating an example of an activation function used in an information processing apparatus according to a third example embodiment.

FIG. 7 is a block diagram illustrating a functional configuration of an information processing apparatus according to a fourth example embodiment.

FIG. 8 is a flowchart illustrating a flow of operation of the information processing apparatus according to the fourth example embodiment.

FIG. 9 is a block diagram illustrating a functional configuration of an information processing apparatus according to a fifth example embodiment.

FIG. 10 is a flowchart illustrating a flow of a likelihood ratio calculation operation in the information processing apparatus according to the fifth example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

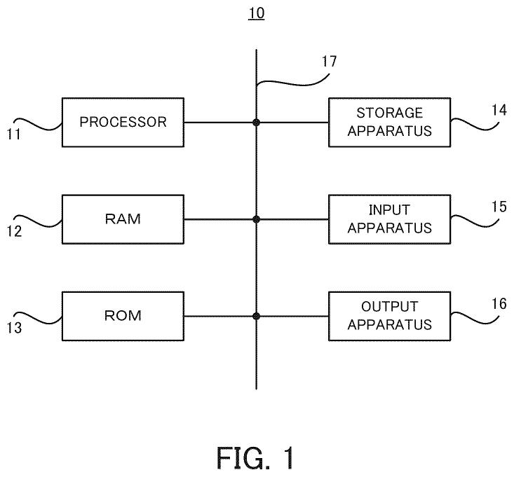

An information processing apparatus according to a first example embodiment will be described with reference to FIG. 1 to FIG. 4.

### Hardware Configuration

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are each connected via a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing class classification based on a likelihood ratio is realized in the processor 11. That is, the processor 11 may function as a controller for executing each control in the information processing apparatus 10.

The processor 11 may be configured as, for example, a CPU (Central Processing Unit), a GPU (Graphics Processing Unit), a FPGA (field-programmable gate array), a DSP (Demand-Side Platform), an ASIC (Application Specific Integrated Circuit), or a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). Furthermore, another type of non-volatile memory may also be used in place of the ROM 13.

The storage apparatus 14 stores data that are stored by the information processing apparatus 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be an apparatus that outputs information in a format other than an image. For example, the output apparatus 16 may be a speaker that audio-outputs the information about the information processing apparatus 10.

Although FIG. 1 illustrates the information processing apparatus 10 including a plurality of apparatuses, all or a part of the functions may be realized in a single apparatus. Such an information processing apparatus may include, for example, only the processor 11, the RAM 12, and the ROM 13. The other components (i.e., the storage apparatus 14, the input apparatus 15, the output apparatus 16, and the like) may be provided in an external apparatus connected to the information processing apparatus 10. In addition, in the information processing apparatus 10, a part of an arithmetic function may be realized by an external apparatus (e.g., an external server or cloud, etc.).

### Functional Configuration

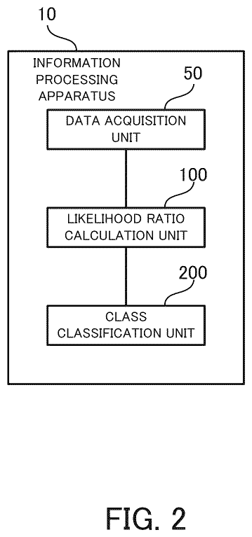

Next, with reference to FIG. 2, a functional configuration of the information processing apparatus 10 according to the first example embodiment will be described. FIG. 2 is a block diagram illustrating the functional configuration of the information processing apparatus according to the first example embodiment.

As illustrated in FIG. 2, the information processing apparatus 10 according to the first example embodiment is an apparatus that performs class classification of series data to be inputted, and includes, as components for realizing the functions thereof, a data acquisition unit 50, a likelihood ratio calculation unit 100, and a class classification unit 200. Each of the data acquisition unit 50, the likelihood ratio calculation unit 100, and the class classification unit 200 may be a processing block realized by the processor 11 (see FIG. 1), for example.

The data acquisition unit 50 is configured to acquire a plurality of elements included in the series data. The data acquisition unit 50 may acquire data directly from an arbitrary data acquisition apparatus (e.g., a camera, a microphone, etc.), or may read data that are acquired in advance by a data acquisition apparatus and that are stored in a storage or the like. When acquiring data from a camera, the data acquisition unit 50 may be configured to acquire the data from each of a plurality of cameras. The elements of the series data acquired by the data acquisition unit 50 are configured to be outputted to the likelihood ratio calculation unit 100. The series data are data including a plurality of elements arranged in a predetermined order, and an example thereof may be time series data, for example. A more specific example of the series data includes, but is not limited to, a subdivision of video data, audio data, or image data.

The likelihood ratio calculation unit 100 is configured to calculate a likelihood ratio, based on at least two consecutive elements out of the plurality of elements acquired by the data acquisition unit 50. The “likelihood ratio” here is an index indicating likelihood of a class to which the series data belong. A specific example of the likelihood ratio and a specific calculation method thereof will be described in detail in another example embodiment later. The likelihood ratio calculation unit 100 according to the present example embodiment is configured to calculate the likelihood ratio by using an activation function. This activation function will be described in detail later.

The class classification unit 200 is configured to classify the series data, based on the likelihood ratio calculated by the likelihood ratio calculation unit 100. The class classification unit 200 selects at least one class to which the series data belong, from among a plurality of classes serving as classification candidates. The plurality of classes serving as classification candidates may be set in advance. Alternatively, the plurality of classes serving as classification candidates may be suitably set by a user, or may be suitably set based on a type of the series data to be handled. For example, the plurality of classes may be set as a class indicating that a face included in video data is a legitimate/real face (i.e., a face of a living body) and a class indicating that the face is a false face (e.g., a photograph or a face of a 3D mask). In this way, the information processing apparatus is usable as a spoofing/impersonation detection apparatus. Note that the number of the plurality of classes serving as classification candidates is not limited to 2, and may be 3 or more.

The information processing apparatus 10 may include a not-illustrated learning unit. Specifically, the information processing apparatus 10 may be configured to have a function of performing learning about calculation of the likelihood ratio. The learning of the information processing apparatus 10 is performed by inputting training data prepared in advance, for example. The training data may be configured as a set of the series data and information about a correct answer class to which the series data belong (i.e., correct answer data), for example. In the learning of the information processing apparatus 10, each parameter of the information processing apparatus 10 may be optimized so as to reduce a loss function calculated by inputting the training data, for example.

### Characteristics of Activation Function

Next, characteristics of the activation function used in the information processing apparatus 10 according to the first example embodiment (specifically, the activation function used by the likelihood ratio calculation unit 100) will be described.

As already described, the likelihood ratio calculation unit 100 according to the present example embodiment is configured to calculate the likelihood ratio by using the activation function. Then, the activation function according to the present example embodiment includes at least the following three characteristics.

The first characteristic is that a value range is wider than [−1,1]. For example, a tanh function or a sigmoid function, which may be used as a generic activation function, has a value range of [−1,1], but the activation function according to the present example embodiment has a wider value range than that of those functions. Therefore, the activation function according to the present example embodiment is highly expressive, as compared with an activation function having a narrow value range. The value range of the activation function according to the present example embodiment may be, for example, [−∞,∞].

The second characteristic is that a change in an output value is milder than a change in an input value. For example, let the input value be x, and the output value be y. A slope of the activation function according to the present example embodiment is gentler than that of y=x. Therefore, the activation function according to the present example embodiment is less likely to diverge even if the input value becomes larger.

The third characteristic is that a gradient at the origin does not diverge. That is, the activation function according to the present example embodiment is considered to have a value that does not diverge when the input is set to 0 after differentiation.

### Flow of Operation

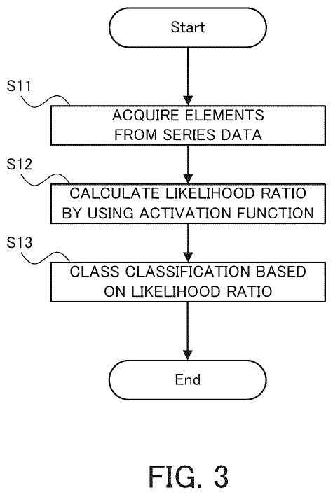

Next, with reference to FIG. 3, a flow of operation of the information processing apparatus 10 according to the first example embodiment will be described. FIG. 3 is a flowchart illustrating the flow of the operation of the information processing apparatus according to the first example embodiment.

As illustrated in FIG. 3, when the operation of the information processing apparatus 10 is started, first, the data acquisition unit 50 acquires the elements included in the series data (step S11). The data acquisition unit 50 outputs the acquired elements of the series data to the likelihood ratio calculation unit 100. Then, the likelihood ratio calculation unit 100 calculates the likelihood ratio, based on the two or more acquired elements (step S12). At this time, the likelihood ratio calculation unit 100 calculates the likelihood ratio by using the activation function including the above-described characteristics.

Subsequently, the class classification unit 200 performs class classification based on the calculated likelihood ratio (step S13). The class classification may be intended to determine one class to which the series data belong, or to determine a plurality of classes to which the series data are likely to belong. The class classification unit 200 may have a function of outputting a result of the class classification. For example, the class classification unit 200 may output the result of the class classification onto a display or the like. Alternatively, the class classification unit 200 may audio-output the result of the class classification via a speaker or the like.

In a case where the calculated likelihood ratio does not exceed a predetermined threshold (i.e., a threshold for determining to which class the series data are classified), the class classification unit 200 may calculate the likelihood ratio again without performing the class classification (i.e., without determining the class to which the series data are classified to). In this instance, the data acquisition unit 50 newly acquires the elements included in the series data, by which a new likelihood ratio may be calculated.

### Technical Effect

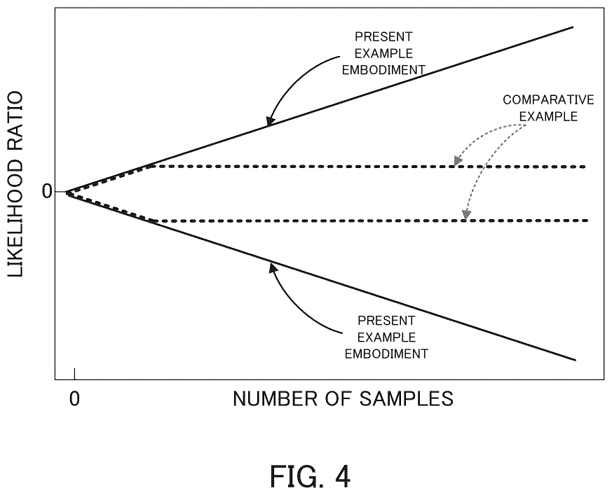

Next, with reference to FIG. 4, a technical effect obtained by the information processing apparatus 10 according to the first example embodiment will be described. FIG. 4 is a graph illustrating with a comparative example, an example of the likelihood ratio calculated by the information processing apparatus according to the first example embodiment.

In FIG. 4, it is preferable that the likelihood ratio used for the class classification gradually changes in one predetermined direction with increasing number of samples (i.e., elements to be inputted). In the comparative example using an activation function differing from that in the present example embodiment, however, the likelihood ratio peaks out or is flatten out (i.e., a change in the likelihood ratio is stopped) even when the number of samples increases.

One of the reasons why the likelihood ratio peaks out is, for example, a narrow threshold of the activation function. Such a state in which the likelihood ratio peaks out does not occur in all cases, but if it does, there is a risk that appropriate class classification may not be possible As a countermeasure for preventing the above-described state in which the likelihood ratio peaks out, for example, it is also conceivable not to use the activation function. However, since the activation function contributes to stable learning, the learning may become unstable if the activation function is not used.

In the information processing apparatus 10 according to the first example embodiment, however, the likelihood ratio is calculated by using the activation function in which the value range is wider than [−1,1], in which the change in the output value is milder than the change in the input value, and in which the gradient at the origin does not diverge. In this way, taking advantage of a high level of expressiveness due to the wide value range of the activation function, it is possible to calculate the likelihood ratio while preventing the above-described state in which the likelihood ratio peaks out. That is, it is possible to calculate the likelihood ratio with high accuracy, for various series data. Furthermore, it is also possible to realize stable learning by using the activation function. That is, in the information processing apparatus 10 according to the first example embodiment, it is possible to achieve both accurate likelihood ratio estimation and stability of learning.

### Second Example Embodiment

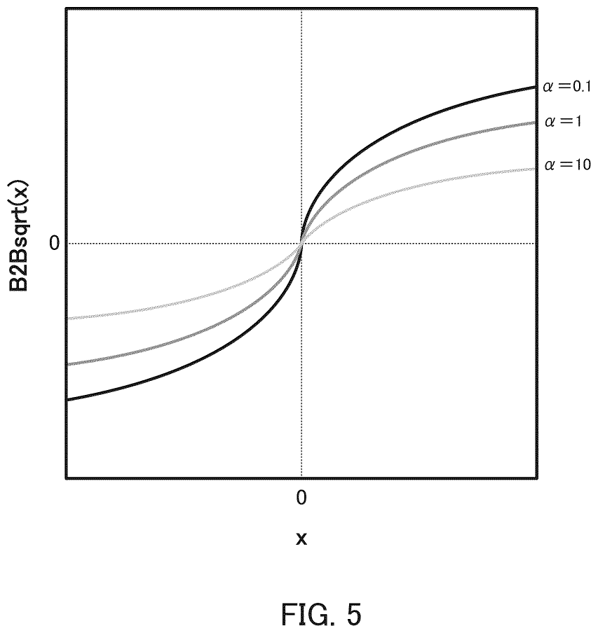

The information processing apparatus 10 according to a second example embodiment will be described with reference to FIG. 5. The second example embodiment describes an example of the activation function, and may be the same as the first example embodiment in the apparatus configuration and the flow of the operation, for example. For this reason, a part differing from the first example embodiment will be described in detail below, and a description of the other overlapping parts will be omitted as appropriate.

### Specific Examples of Activation Function

First, a specific example of the activation function used in the information processing apparatus 10 according to the second example embodiment will be described with reference to FIG. 5. FIG. 5 is a graph illustrating an example of the activation function used in the information processing apparatus according to the second example embodiment.

In FIG. 5, the information processing apparatus 10 according to the second example embodiment uses an activation function in which square root functions are combined so as to be point-symmetrical around the origin. In the following, this activation function is referred to as a Back-to-Back-square-root function (a B2Bsqrt function). The B2Bsqrt function satisfies the three characteristics already described (i.e., the value range is wider than [−1,1], the change in the output value is milder than the change in the input value, and the slope at the origin does not diverge). An example of the B2Bsqrt function is, for example, a function f₁ illustrated in the following Equation (1).

### Equation 1

f₁=sign(x) (\sqrt{α+|x|}−\sqrt{α}) . . . (1)

Here, “x” is the input value, and “α” is a predetermined coefficient (a hyper parameter). As illustrated in FIG. 5, a shape of the function is changed by changing a value of α. The B2Bsqrt function in the above Equation (1) is merely an example, and may be changeable as appropriate, as long as it satisfies the three characteristics required for the activation function according to the present example embodiment.

### Technical Effect

Next, a technical effect obtained by the information processing apparatus 10 according to the second example embodiment will be described.

In the information processing apparatus 10 according to the second example embodiment, the B2Bsqrt function in which the square root functions are combined, is used as the activation function. Since this B2Bsqrt function has the characteristics in which the value range is wider than [−1,1], in which the change in the output value is milder than the change in the input value, and in which the gradient at the origin does not diverge, it is possible to achieve both accurate likelihood ratio estimation and stability of learning, as described in the first example embodiment.

### Third Example Embodiment

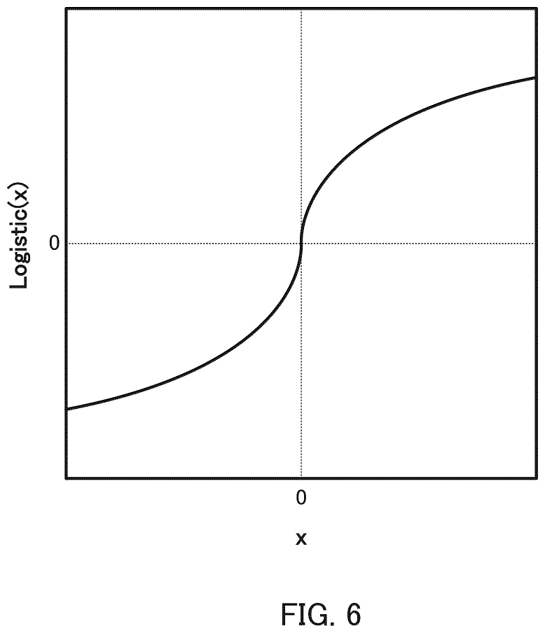

The information processing apparatus 10 according to a third example embodiment will be described with reference to FIG. 6. The third example embodiment describes an example of the activation function as in the second example embodiment, and may be the same as the first example embodiment in the apparatus configuration and the flow of the operation, for example. For this reason, a part differing from each of the example embodiments described above will be described in detail below, and a description of the other overlapping parts will be omitted as appropriate.

### Specific Examples of Activation Function

First, a specific example of the activation function used in the information processing apparatus 10 according to the third example embodiment will be described with reference to FIG. 6. FIG. 6 is a diagram illustrating an example of the activation function used in the information processing apparatus according to the third example embodiment.

As illustrated in FIG. 6, the information processing apparatus 10 according to the third example embodiment uses an activation function in which log functions are combined so as to be point-symmetrical around the origin. In the following, this activation function is referred to as a logistic-activation function. The logistic-activation function satisfies the three characteristics already described (i.e., the value range is wider than [−1,1], the change in the output value is milder than the change in the input value, and the slope at the origin does not diverge). An example of the logistic-activation function is, for example, a function f₂ illustrated in the following Equation (2).

### Equation 2

f₂=sign(x) (log (α+|x|) . . . (2)

Here, “x” is the input value, and “α” is a predetermined coefficient (a hyper parameter). The logistic-activation function in the above Equation (2) is merely an example, and may be changeable as appropriate, as long as it satisfies the three characteristics required for the activation function according to the present example embodiment.

### Technical Effect

Next, a technical effect obtained by the information processing apparatus 10 according to the third example embodiment will be described.

In the information processing apparatus 10 according to the third example embodiment, the logistic-activation function in which the log functions are combined, is used as the activation function. Since this logistic-activation function has the characteristics in which the value range is wider than [−1,1], in which the change in the output value is milder than the change in the input value, and in which the gradient at the origin does not diverge, it is possible to achieve both accurate likelihood ratio estimation and stability of learning, as described in the first example embodiment.

### Fourth Example Embodiment

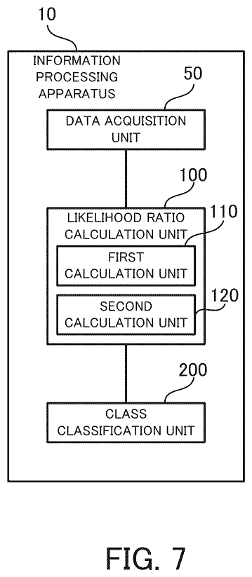

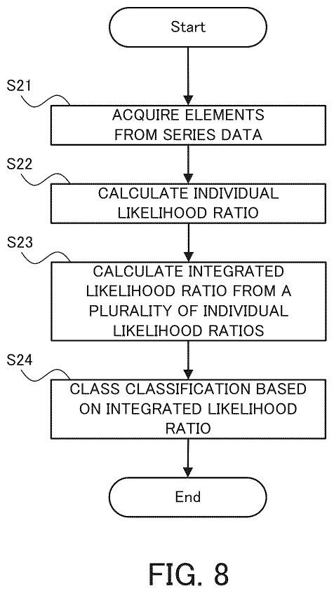

The information processing apparatus 10 according to a fourth example embodiment will be described with reference to FIG. 7 and FIG. 8. The fourth example embodiment partially differs from the first to third example embodiments only in the configuration and operation, and may be the same as the first to third example embodiments in the other parts. For this reason, a part differing from each of the example embodiments described above will be described in detail below, and a description of the other overlapping parts will be omitted as appropriate.

### Functional Configuration

First, with reference to FIG. 7, a functional configuration of the information processing apparatus 10 according to the fourth example embodiment will be described. FIG. 7 is a block diagram illustrating the functional configuration of the information processing apparatus according to the fourth example embodiment. In FIG. 7, the same components as those illustrated in FIG. 2 carry the same reference numerals.

As illustrated in FIG. 7, the information processing apparatus 10 according to the fourth example embodiment includes, as components for realizing the functions thereof, the data acquisition unit 50, the likelihood ratio calculation unit 100, and the class classification unit 200. Especially in the fourth example embodiment, the likelihood ratio calculation unit 100 includes a first calculation unit 110 and a second calculation unit 120. Each of the first calculation unit 110 and the second calculation unit 120 may be realized by the processor 11 (see FIG. 1), for example.

The first calculation unit 110 is configured to calculate an individual likelihood ratio, based on two consecutive elements included in the series data. The individual likelihood ratio is calculated as a likelihood ratio indicating likelihood of a class to which two consecutive elements belong. The first calculation unit 110 may sequentially acquire the elements included in the series data from the data acquisition unit 50, and may sequentially calculate the individual likelihood ratio based on the two consecutive elements, for example. The individual likelihood ratio calculated by the first calculation unit 110 is configured to be outputted to the second calculation unit 120.

The second calculation unit 120 is configured to calculate an integrated likelihood ratio, based on a plurality of individual likelihood ratios calculated by the first calculation unit 110. The integrated likelihood ratio is calculated as a likelihood ratio indicating likelihood of a class to which a plurality of elements considered in each of the plurality of individual likelihood ratios belong. In other words, the integrated likelihood ratio is calculated as a likelihood ratio indicating likelihood of a class to which the series data including a plurality of elements belongs. The integrated likelihood ratio calculated by the second calculation unit 120 is configured to be outputted to the class classification unit 200. The class classification unit 200 performs the class classification of the series data, based on the integrated likelihood ratio.

### Flow of Operation

Next, with reference to FIG. 8, a flow of operation of the information processing apparatus 10 according to the fourth example embodiment will be described. FIG. 8 is a flowchart illustrating the flow of the operation of the information processing apparatus according to the fourth example embodiment.

As illustrated in FIG. 8, when the operation of the information processing apparatus 10 according to the fourth example embodiment is started, first, the data acquisition unit 50 acquires the elements included in the series data (step S21). The data acquisition unit 50 outputs the acquired elements of the series data to the first calculation unit 110.

Then, the first calculation unit 110 calculates the individual likelihood ratio, based on the acquired two consecutive elements (step S22). Thereafter, the second calculation unit 120 calculates the integrated likelihood ratio, based on the plurality of individual likelihood ratios calculated by the first calculation unit 110 (step S23).

Subsequently, the class classification unit 200 performs the class classification, based on the calculated integrated likelihood ratio (step S24). The class classification may be intended to determine one class to which the series data belong, or to determine a plurality of classes to which the series data are likely to belong.

### Technical Effect

Next, a technical effect obtained by the information processing apparatus 10 according to the fourth example embodiment will be described.

As described in FIG. 7 and FIG. 8, in the information processing apparatus 10 according to the fourth example embodiment, first, the individual likelihood ratio is calculated based on the two elements, and then, the integrated likelihood ratio is calculated based on the plurality of individual likelihood ratios. By using the integrated likelihood ratio calculated in this manner, it is possible to properly select the class to which the series data belong. Furthermore, in the information processing apparatus 10 according to the fourth example embodiment, each likelihood ratio is calculated by using the activation function described above, and it is therefore possible to achieve both accurate likelihood ratio estimation and stability of learning.

### Fifth Example Embodiment

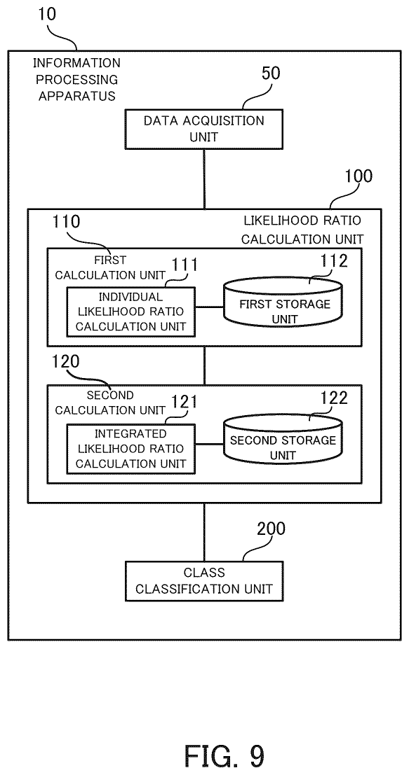

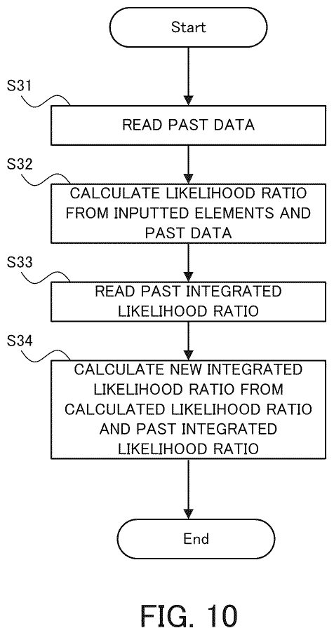

The information processing apparatus 10 according to a fifth example embodiment will be described with reference to FIG. 9 and FIG. 10. The fifth example embodiment partially differs from the fourth example embodiment only in the configuration and operation, and may be the same as the fourth example embodiment in the other parts. For this reason, a part differing from each of the example embodiments described above will be described in detail below, and a description of the other overlapping parts will be omitted as appropriate.

### Functional Configuration

First, with reference to FIG. 9, a functional configuration of the information processing apparatus 10 according to the fifth example embodiment will be described. FIG. 9 is a block diagram illustrating the functional configuration of the information processing apparatus according to the fifth example embodiment. In FIG. 9, the same components as those illustrated in FIG. 2 and FIG. 7 carry the same reference numerals.

As illustrated in FIG. 9, the information processing apparatus 10 according to the fifth example embodiment includes, as components for realizing the functions thereof, the data acquisition unit 50, the likelihood ratio calculation unit 100, and the class classification unit 200. The likelihood ratio calculation unit 100 includes the first calculation unit 110 and the second calculation unit 120, as in the fourth example embodiment. Furthermore, in the fifth example embodiment, the first calculation unit 110 includes an individual likelihood ratio calculation unit 111 and a first storage unit. The second calculation unit 120 includes an integrated likelihood ratio calculation unit 121 and a second storage unit 122. Each of the individual likelihood ratio calculation unit 111 and the integrated likelihood ratio calculation unit 121 may be a processing block realized by the processor 11 (see FIG. 1), for example. Furthermore, each of the first storage unit 112 and the second storage unit 122 may be realized by the storage apparatus 14 (see FIG. 1), for example.

The individual likelihood ratio calculation unit 111 is configured to calculate the individual likelihood ratio, based on two consecutive elements out of the elements sequentially acquired by the data acquisition unit 50. More specifically, the individual likelihood ratio calculation unit 111 calculates the individual likelihood ratio, based on newly acquired elements and past data stored in the first storage unit 112. Information stored in the first storage unit 112 is configured to be readable by the individual likelihood ratio calculation unit 111. In a case where the first storage unit 112 stores a past individual likelihood ratio, the individual likelihood ratio calculation unit 111 may read the stored past individual likelihood ratio and may calculate a new individual likelihood ratio in consideration of the acquired elements. On the other hand, in a case where the first storage unit 112 stores the elements themselves acquired in the past, the individual likelihood ratio calculation unit 111 may calculate a past individual likelihood ratio from the stored past elements and may calculate a likelihood ratio for the newly acquired elements.

The integrated likelihood ratio calculation unit 121 is configured to calculate the integrated likelihood ratio, based on a plurality of individual likelihood ratios. The integrated likelihood ratio calculation unit 121 calculates a new integrated likelihood ratio, by using the individual likelihood ratio calculated by the individual likelihood ratio calculation unit 111 and a past integrated likelihood ratio stored in the second storage unit 122. Information stored in the second storage unit 122 (i.e., the past integrated likelihood ratio) is configured to be readable by the integrated likelihood ratio calculation unit 121.

### Likelihood Ratio Calculation Operation

Next, with reference to FIG. 10, a flow of a likelihood ratio calculation operation (i.e., an operation when the likelihood ratio calculation unit 100 calculates the likelihood ratio) in the information processing apparatus 10 according to the seventh example embodiment will be described. FIG. 10 is a flowchart illustrating the flow of the likelihood ratio calculation operation in the information processing apparatus according to the fifth example embodiment.

As illustrated in FIG. 10, when the likelihood ratio calculation operation according to the fifth example embodiment is started, first, the individual likelihood ratio calculation unit 111 in the first calculation unit 110 reads the past data from the first storage unit 112 (step S31). The past data may be, for example, a processing result in the individual likelihood ratio calculation unit 111 for an element obtained one before an element acquired this time by the data acquisition unit 50 (in other words, an individual likelihood ratio calculated for the element one before). Alternatively, the past data may be the element itself acquired one before the element acquired this time.

Subsequently, the individual likelihood ratio calculation unit 111 calculates a new individual likelihood ratio (i.e., ab individual likelihood ratio for the element acquired this time by the data acquisition unit 50), based on the element acquired by the data acquisition unit 50 and the past data read from the first storage unit 112 (step S32). The individual likelihood ratio calculation unit 111 outputs the calculated individual likelihood ratio to the second calculation unit 120. The individual likelihood ratio calculation unit 111 may store the calculated individual likelihood ratio in the first storage unit 112.

Subsequently, the integrated likelihood ratio calculation unit 121 in the second calculation unit 120 reads the past integrated likelihood ratio from the second storage unit 122 (step S33). The past integrated likelihood ratio may be, for example, a processing result of the integrated likelihood ratio calculation unit 121 for the element acquired one before the element acquired this time by the data acquisition unit 50 (in other words, an integrated likelihood ratio calculated for the element one before).

Subsequently, the integrated likelihood ratio calculation unit 121 calculates a new integrated likelihood ratio (i.e., an integrated likelihood ratio for the element acquired this time by the data acquisition unit 50), based on the likelihood ratio calculated by the individual likelihood ratio calculation unit 111 and the past integrated likelihood ratio read from the second storage unit 122 (step S34). The integrated likelihood ratio calculation unit 121 outputs the computed integrated likelihood ratio to the class classification unit 200. The integrated likelihood ratio calculation unit 121 may store the calculated integrated likelihood ratio in the second storage unit 122.

### Technical Effect

Next, a technical effect obtained by the information processing apparatus 10 according to the fifth example embodiment will be described.

As described with reference to FIG. 9 and FIG. 10, in the information processing apparatus 10 according to the fifth example embodiment, the individual likelihood ratio is calculated by using the past individual likelihood ratio, and then, the integrated likelihood ratio is calculated by using the past integrated likelihood ratio. By using the integrated likelihood ratio calculated in this manner, it becomes possible to properly select the class to which the series data belong. Furthermore, even in the information processing apparatus 10 according to the fifth example embodiment, each likelihood ratio is calculated by using the activation function described above, and it is therefore possible to achieve both accurate likelihood ratio estimation and stability of learning.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### Supplementary Note 1

An information processing apparatus according to Supplementary Note 1 is an information processing apparatus including: an acquisition unit that acquires a plurality of elements included in series data; a calculation unit that calculates a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and a classification unit that classifies the series data into at least one class of a plurality of classes serving as classification candidates, based on the likelihood ratio.

### Supplementary Note 2

An information processing apparatus according to Supplementary Note 2 is the information processing apparatus according to Supplementary Note 1, wherein the activation function is a function in which square root functions are combined so as to be point-symmetrical around the origin.

### Supplementary Note 3

An information processing apparatus according to Supplementary Note 3 is the information processing apparatus according to Supplementary Note 2, wherein the activation function includes f=sign(x){(α+|x|)^{1/2}−α^{1/2}}, (x: input value, α: predetermined coefficient).

### Supplementary Note 4

An information processing apparatus according to Supplementary Note 4 is the information processing apparatus according to Supplementary Note 1, wherein the activation function is a function in which log functions are combined so as to be point-symmetrical around the origin.

### Supplementary Note 5

An information processing apparatus according to Supplementary Note 5 is the information processing apparatus according to Supplementary Note 4, wherein the activation function includes f=sign(x){log(α+|x|)}, (x: input value, a: predetermined coefficient).

### Supplementary Note 6

An information processing method according to Supplementary Note 6 is an information processing method that is executed by at least one computer, the information processing method including: acquiring a plurality of elements included in series data; calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and classifying the series data into at least one class of a plurality of classes serving as classification candidates, based on the likelihood ratio.

### Supplementary Note 7

A recording medium according to Supplementary Note 7 is a recording medium on which a computer program that allows at least one computer to execute an information processing method is recorded, the information processing method including: acquiring a plurality of elements included in series data; calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and classifying the series data into at least one class of a plurality of classes serving as classification candidates, based on the likelihood ratio.

### Supplementary Note 8

A computer program according to Supplementary Note 8 is a computer program that allows at least one computer to execute an information processing method, the information processing method including: acquiring a plurality of elements included in series data; calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and classifying the series data into at least one class of a plurality of classes serving as classification candidates, based on the likelihood ratio.

### Supplementary Note 9

An information processing system according to Supplementary Note 9 is an information processing system including: an acquisition unit that acquires a plurality of elements included in series data; a calculation unit that calculates a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and a classification unit that classifies the series data into at least one class of a plurality of classes serving as classification candidates, based on the likelihood ratio.

The present disclosure is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

10 Information processing apparatus
50 Data acquisition unit
100 Likelihood ratio calculation unit
110 First calculation unit
111 Individual likelihood ratio calculation unit
112 First storage unit
120 Second calculation unit
121 Integrated likelihood ratio calculation unit
122 Second storage unit
200 Class classification unit

What is claimed is:

1. An information processing apparatus comprising:
at least one memory that is configured to store instructions; and
at least one processor that is configured to execute the instructions to:
acquire a plurality of elements included in series data;
calculate a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and
classify the series data into at least one class of a plurality of classes serving as classification candidates, based on the likelihood ratio.

2. The information processing apparatus according to claim 1, wherein the activation function is a function in which square root functions are combined so as to be point-symmetrical around the origin.

3. The information processing apparatus according to claim 2, wherein the activation function includes
f=sign(x){(α+|x|)^{1/2}−α^{1/2}},
(x: input value, α: predetermined coefficient).

4. The information processing apparatus according to claim 1, wherein the activation function is a function in which log functions are combined so as to be point-symmetrical around the origin.

5. The information processing apparatus according to claim 4, wherein the activation function includes
f=sign(x){log(α+|x|)},
(x: input value, α: predetermined coefficient).

6. An information processing method that is executed by at least one computer, the information processing method comprising:
acquiring a plurality of elements included in series data;
calculating a likelihood ratio indicating likelihood of a class to which the series data belong, from at least two consecutive elements out of the plurality of elements, by using an activation function in which a value range is wider than [−1,1], in which a change in an output value is milder than a change in an input value, and in which a gradient at an origin does not diverge; and
classifying the series data into at least one class of a plurality of classes serving as classification candidates, based on the likelihood ratio.

7. A non-transitory recording medium on which a computer program that allows at least one computer to execute an information processing method is recorded, the information processing method including:
acquiring a plurality of elements included in series data;
calculating a likelihood ratio indicating likelihood of a class to which the series data belong, from at least two consecutive elements out of the plurality of elements, by using an activation function in which a value range is wider than [−1, 1], in which a change in an output value is milder than a change in an input value, and in which a gradient at an origin does not diverge; and
classifying the series data into at least one class of a plurality of classes serving as classification candidates, based on the likelihood ratio.
